(19) United States
(12) Patent Application Publication
(10) Pub. No.: US 2017/0193171 A1
(43) Pub. Date: Jul. 6, 2017

(54) PERSONALIZED MULTI-DIMENSIONAL HEALTH CARE PROVIDER-PATIENT MATCHING

(71) Applicant: Lyra Health, Inc., Burlingame, CA (US)

(72) Inventors: Daniella Perlroth, Palo Alto, CA (US); Aaron Archer Waterman, Mountain View, CA (US)

(21) Appl. No.: 14/988,051

(22) Filed: Jan. 5, 2016

(51) Int. Cl. G06F 19/00

(52) U.S. Cl. CPC G06F 19/327; G06Q 50/22

(57) ABSTRACT

A personalized health care provider matching service is provided to rank and select the best matched health care providers for a patient across multiple dimensions according to the patient's medical conditions, non-medical factors and treatment preferences. Each medical condition of the patient represents a dimension. The service measures a provider's level of competency for treating a medical condition, e.g., based on the provider's drug prescription patterns in treating the medical condition measured against a reference practice standard. The provider matching service ranks the providers across the multiple medical conditions/treatment needs of a patient, where the rankings of the providers represent the providers' competency across multiple dimensions. The provider matching service assesses a patient's needs across different medical conditions and applies different weights to different corresponding dimensions in ranking the providers. The provider matching service selects one or more the best matched providers to the patient based on the providers' rankings.

### BACKGROUND

This disclosure relates generally to matching patients with health care providers, and particularly to a personalized, multi-dimensional health care provider matching service that ranks and selects the best matched health care providers for a patient according to the patient's medical conditions and preferences for treatment.

Patient care empowered by digital computing can reduce inefficiencies in health care delivery, improve access, reduce costs, increase quality, and provide more personalized and precise patient care. One important aspect of personalized health care is finding competent health care providers for a given patient according to the patient's medical conditions and preferences for treatment. Behavioral health is one area in particular where it has been difficult or impossible for patients to find the right psychiatrist or therapist.

Unfortunately, there are several drawbacks with currently existing methods for patients to find suitable health care providers. Patients can, for example, search online and through other sources for health care providers that match both their medical conditions and preferences for treatment. However, the amount of information available to them and difficulty in understanding the information can be overwhelming, which consequently results in reduced quality of patient care and many patients simply going untreated. There are also some existing methods to automatically assign health care providers to a patient, but these do not consider various factors that may directly affect outcome of a treatment, such as the patient's preferences for treatment, including types of health care providers and types of drugs preferred by the patient. Such drawbacks are especially prominent in matching competent behavioral health care providers with patients having a need for treatment because such patients often have personal preferences for types of treatment and may only respond positively to their preferred treatment. Thus, again many patients get poorly matched treatment or ultimately go untreated.

### SUMMARY

A personalized multi-dimensional health care provider matching service is provided to rank and select the best matched health care providers for a patient across multiple dimensions according to the patient's medical conditions and preferences for treatment. Each medical condition of the patient represents a dimension; additional medical conditions of the patient represent additional dimensions in which to rank the providers for the patient. Other factors, such as cost of treatment, location distance from a provider, can also represent dimensions. The provider matching service measures a provider's level of competency for treating a medical condition, e.g., based on the provider's drug prescription patterns in treating the medical condition compared against a reference practice standard (e.g., UpToDate® or First DataBank recommendation for treating the medical condition). The provider matching service ranks multiple providers based on their levels of competency in terms of treating the same medical condition.

Each medical condition may have one or more treatment options, e.g., medication, psychotherapy and both. The provider matching service ranks the providers across the multiple medical conditions/treatment needs of a patient, where the rankings of the providers represent the providers' competency across multiple medical dimensions or labels that describe the characteristics of the providers across multiple non-medical dimensions such as in cost and location distance dimensions. In one embodiment, the provider matching service accesses a patient's needs across different medical conditions and applies different weights to different corresponding dimensions in ranking the providers. The different weights assigned to different dimensions are based on the severity of each medication condition applicable to the patient's needs. The provider matching service selects one or more providers best matched to the patient based on the providers' multi-dimensional rankings. The multi-dimensional ranking is performed dynamically at the time that patient data is submitted. Each dimensional ranking is unique and customized to each individual patient. Thus, the provider matching service provides a scalable, multiple-objective algorithm to match the unique needs of the patient to the unique strengths of the provider.

The provider matching service also provides a user friendly service to a patient such that the patient can easily find best matched providers according to his/her medical conditions and preferences for treatment. For example, a patient may use a client device, e.g., a mobile phone, laptop or personal computer, which executes a provider matching application provided by the provider matching service, to input his/her medical conditions and preferences for treatment and to request providers that best match his/her medical needs. The provider matching service receives such a request from a client device of a patient, searches the providers in a provider database, and selects one or more providers that best match the patient's need based on the providers' multi-dimensional rankings. The provider matching service instructs the patient's client device to present the selected providers in a user friendly way, such as by including providers' contact information, web links to the providers' profiles and offices, etc.

For purposes of simplicity and the description of one embodiment, the provider matching service is described herein with reference to behavioral health providers, such as psychiatrists, with respect to medical conditions and treatments in the behavioral health space, but no limitation on the types of providers and medical conditions are intended by this simplicity. Thus, the operations described herein for ranking behavioral health care providers can be applied to any other types of health care providers, e.g., various different physicians, hospitals, skilled nursing facilities, and ambulatory surgical centers.

Similarly, for simplicity, the operations described herein for ranking health care providers with references to multiple dimensions represented by medical conditions, but no limitations on the dimension representations are intended by this simplicity. For example, the dimensions can be represented by non-medical conditions, such as cost of treatment and location distance from a provider. The health care providers can be ranked across multiple medical dimensions, non-medication dimensions or the combination of both. For example, the health care providers can be ranked across multiple medical dimensions based on the providers' competency for treading the medical conditions; the health care providers can also be ranked across multiple non-competency based dimensions represented by characteristics of the providers in treating their patients.

### BRIEF DESCRIPTION OF THE DRAWINGS

FIG. 1 is a block diagram of a computing environment for matching health care providers to a patient based on the patient's medical conditions and preferences for treatment according to one embodiment.

FIG. 2 is a block diagram of a matching module of a provider matching service to provide best matched providers to a patient according to one embodiment.

FIG. 3A is a graph illustrating exemplary diversity of medication prescription for a behavioral health condition from three different types of providers across two lines of medications according to one embodiment.

FIG. 3B is a graph illustrating exemplary diversity of medication prescription by psychiatrists across a first line medication according to one embodiment.

FIG. 3C is a graph illustrating exemplary concentration of a first line medication prescription from providers according to one embodiment.

FIG. 4 is a graph illustrating exemplary multi-dimensional rankings for two different medical conditions according to one embodiment.

FIG. 5 is a flowchart illustrating a process of matching health care providers with a patient's need based on the patient's medical conditions and preferences for treatment according to one embodiment.

FIG. 6A illustrates an example of a graphical user interface on a client device for a patient to take a medical survey, which is considered by the provider matching service, according to one embodiment.

FIG. 6B illustrates an example of a graphical user interface on a client device for a patient to input his/her medical conditions, which are considered by the provider matching service, according to one embodiment.

FIG. 6C illustrates an example of a graphical user interface on a client device for a patient to select his/her location preference for treatment, which is considered by the provider matching service, according to one embodiment.

FIG. 6D illustrates an example of a graphical user interface on a client device for a patient to select his/her preference for treatment options, which is considered by the provider matching service, according to one embodiment.

FIG. 7 is a flow diagram of providing best matched providers to a patient based on the providers' multi-dimensional rankings according to one embodiment.

The figures depict various embodiments of the invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Overview

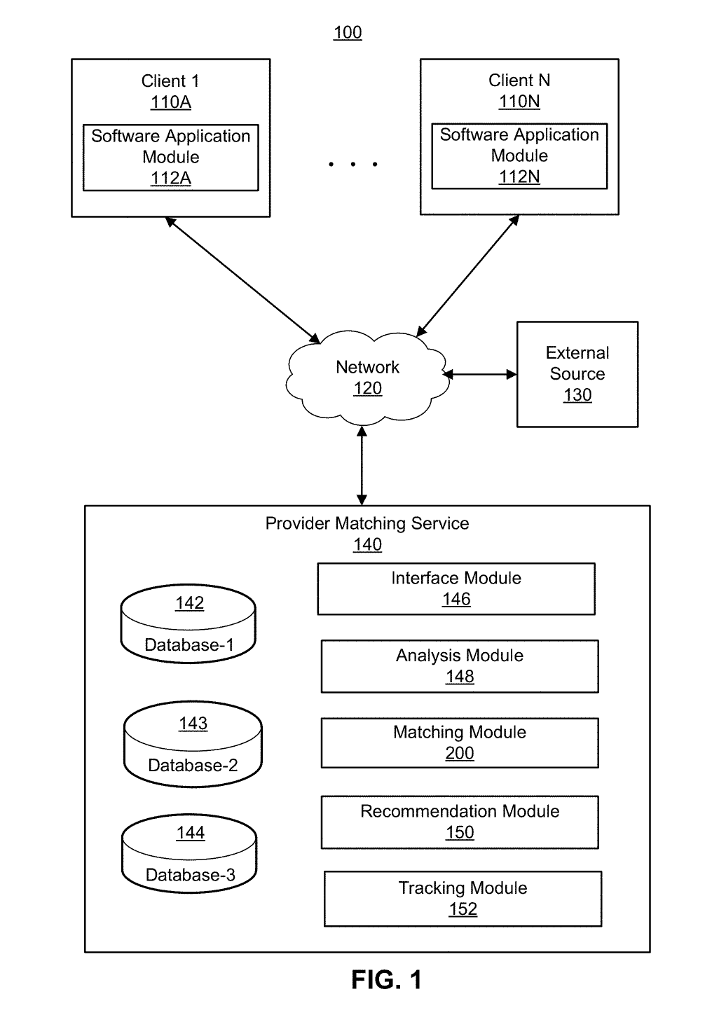

FIG. 1 is a block diagram of a computing environment 100 for matching health care providers with a patient's need based on the patient's medical conditions and preferences for treatment according to one embodiment. The embodiment illustrated in FIG. 1 includes multiple client devices 110 (e.g., 110A and 110N), a provider matching service 140, and an external source 130 connected to each other by a network 120. Embodiments of the computing environment 100 can have many client devices 110, provider matching services 140, and external sources 130 connected to the network 120. Likewise, the functions performed by the various entities of FIG. 1 may differ in different embodiments.

A client device, e.g., 110A, is an electronic device used by a patient to perform functions such as requesting best matched health providers based on the patient's medical conditions and preferences for treatment, executing software applications, consuming digital content, browsing websites hosted by web servers on the network 120, downloading files, and the like. For example, the client device 110 may be a mobile device, a tablet, a notebook, a desktop computer, or a portable computer. The client device 110 includes interfaces with a display device on which the user may view webpages, videos and other content. In addition, the client device 110 provides a user interface (UI), such as physical and/or on-screen buttons with which the user may interact with the client device 110 to perform functions such as viewing, selecting, and consuming digital content such as digital medical records, webpages, photos, videos and other content.

In one embodiment, the client device 110 has a software application module 112 (e.g., 112A for client device 110A and 112N for client device 110N) for executing a provider matching software application configured to find best matched health care providers for a patient based on the patient's medical conditions and preferences for treatment. The software application is executed to provide a patient's input, such as the patient's medical conditions and preferences for treatment, to the provider matching service 140 to request health care providers that match his/her medical conditions and preferences for treatment, and to receive matched providers' information from the provider matching service 140. For example, upon executing the software application installed in the client device 110, the software application module 112 communicates with the provider matching service 140 to send a request for health care providers for a patient using the client device 110. The user of the client device 110 (e.g., the patient herself or himself, or family, friends, caregivers, practitioners, hospitals, a health care service, a skilled nursing facility, an ambulatory surgical center, and some combination thereof) can request health care providers for the patient based on the patient's medical conditions and preferences for treatment. Upon receiving the matched providers' information from the provider matching service 140, the software application module 112 presents the providers' information in an intuitive and user friendly way, e.g., showing the location of an identified provider on a map next to the provider's contact information and web link.

The software application module 112 can be similarly installed and executed on computing devices associated with additional caregivers, family members, friends, qualified practitioners, hospitals, health care services, skilled nursing facilities, and ambulatory surgical centers that have been granted permission to participate in using the provider matching service on behalf of the patient. The software application module 112 can be a standalone application that a patient downloads and uses on a client device 110, or can be integrated into an employee health plan or wellness program at a company at which the patient is employed. In the latter case, the company may also have a software application installed on company devices through which a benefits team can interact with and manage this benefit for employees. Similarly providers can have software applications installed on their devices or devices associated with their healthcare facility that allow providers to track their patients.

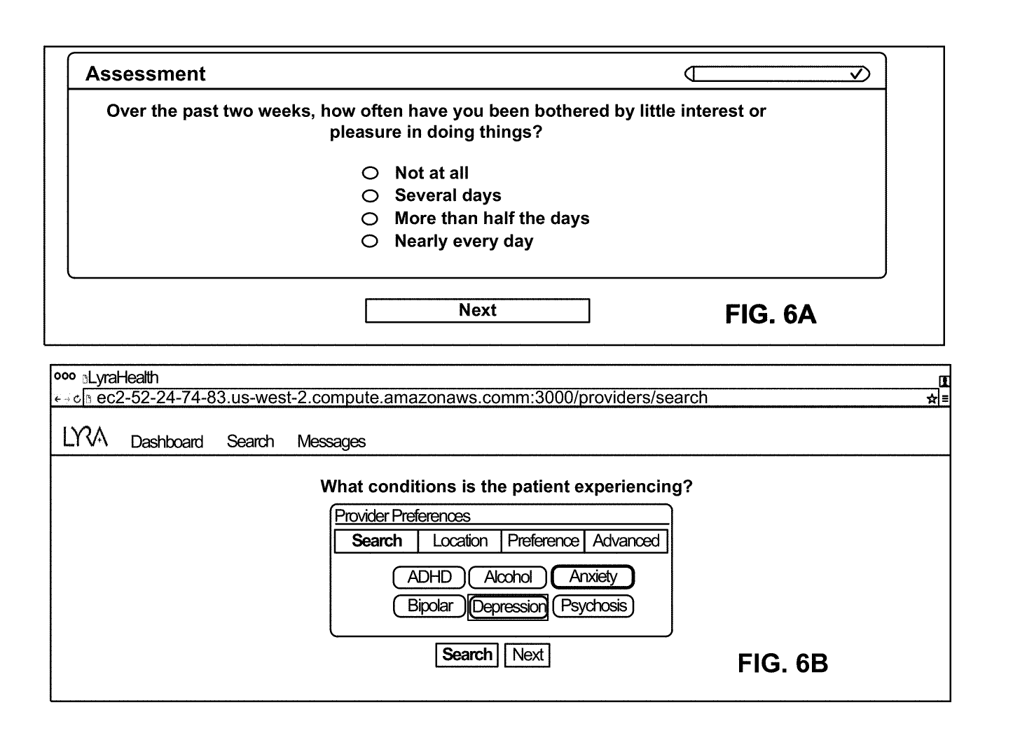

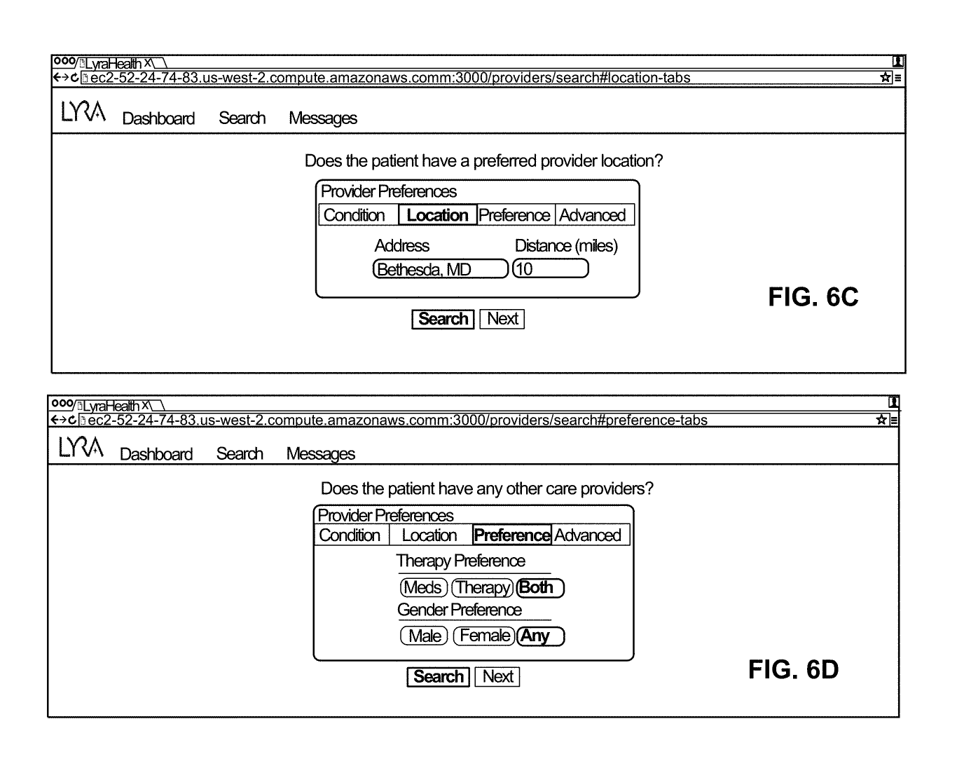

The software application module 112 presents a user friendly interface for guiding a patient to find the best matched health care provider using the provider matching application executed on the client device 110. FIG. 6A to FIG. 6D illustrate examples of a graphical user interface executed by the software application module 112 on the client device 110 such that a patient who uses the client device 110 can input his/her unique medical needs. The patient's input, such as the patient's medical conditions and preferences for treatment (e.g., location, types of providers and treatment) are considered by the provider matching service 140 to find best matched providers for the patient.

FIG. 6A shows an example of a graphical user interface on a client device 110 for a patient to take a medical survey, which is considered by the provider matching service 140 according to one embodiment. The user interface presents a question to a patient regarding the patient's mental well-being for the past two weeks and provides four possible answers for the patient to select. This medical survey is used by the provider matching service 140 to screen a patient's mental well-being over a period of time. For example, from the patient's answer choice, the provider matching service 140 determines severity of the patient's mental health condition. If the patient's answer indicates that the patient stayed mentally active, (e.g., selecting one of the first 2 answers), that means the patient's mental health condition is probably not severe. If the patient's answer indicates that the patient has shown signs of depression (e.g., selecting one of the last 2 answers), that means the patient's mental health condition is probably severe, and more comprehensive diagnosis may be required. In some embodiments, there are a variety of questions presented to the patient to assess the patient's current mental health state. As one example, if the patient screens negative for a mental health condition, the patient may not receive additional questions. However, if the user screens positive for a mental health condition, the patient may receive a number of additional questions designed to confirm the mental health condition and assess severity. In some embodiments, a report is generated for the patient's primary care physician based on the results of the screening.

FIG. 6B illustrates an example of a graphical user interface on a client device 110 for a patient to input his/her medical condition, which is considered by the provider matching service 140, according to one embodiment. The user interface shown in FIG. 6B lists 6 medical conditions from which a patient can select: attention deficit hyperactivity disorder (ADHD), post-traumatic stress disorder (PTSD), specific phobia, social anxiety, alcohol abuse, anxiety, bipolar, depression, schizophrenia and psychosis. Each medical condition selected by the patient represents a dimension in multi-dimensional ranking performed by the provider matching service 140 to rank providers that provide treatments for that medical condition. Each additional medical condition of the patient represents an additional dimension in the multi-dimensional ranking performed by the provider matching service 140. In some embodiments, the current state of the patient's mental health and the patient's conditions are determined, derived or received from another source (e.g., the patient's primary care physician, or patent screening tools) other than from the patient via user interfaces, such as those in FIGS. 6A and 6B.

In addition to allowing a patient to indicate his/her mental health condition (as shown in FIG. 6A) and medical condition (as shown in FIG. 6B), the software application module 112 enables a patient to indicate his/her preferences for treatment. Examples of a patient's treatment preferences include geographical location, time available, language preferences, gender, age, cultural considerations, medical groups included, and insurance plans accepted. Additional examples of a patient's treatment preferences may be automatically selected by the software application module 112 when not explicitly indicated by the patient, including safety considerations (e.g., avoidance of providers tending to prescribe medications for pain, benzodiazepines and stimulants). FIG. 6C illustrates an example of a graphical user interface on a client device 110 for a patient to select his/her location preference for treatment (e.g., in terms of specific location address or distance); FIG. 6D illustrates an example of a graphical user interface on a client device 110 for a patient to select his/her preference for treatment options (e.g., medication only, psychotherapy only or both).

All the information obtained from the above steps shown through FIG. 6A and FIG. 6D is used by the provider matching service 140 for ranking providers for the patient in multiple dimensions. For example, each medical condition selected by the patient is considered as one dimension. Each medical condition may have one or more treatment options, e.g., medication and psychotherapy. Using the examples shown above, the provider matching service 140 has a total of 12 dimensions (6 medical conditions*2 methods of treatments) to rank the providers for the patient. The patient's preferences for a treatment, such as, location, time, language, etc., are used by the provider matching service 140 to filter out providers that do not match the patient's preferences, and the remaining providers in the filtered set can be ranked by the provider matching service 140. In some embodiments, the provider matching service 140 can also rank providers on some or all of the patient's preferences for treatment/providers rather than filtering out providers who do not meet the preferences. For example, a patient may have a slight preference for a female provider, but if certain male providers are very well matched to the patient, the patient may wish to consider these male providers. The patent's preferences for treatments, such as cost of treatment and location distance from a provider are considered as ranking dimensions and are used in ranking the providers. Thus, including a wider set of providers in the overall ranking can allow this type of consideration.

Turning back to FIG. 1, the network 120 enables communications among network entities such as the client devices 110, the provider matching service 140, and the external source 130. In one embodiment, the network 120 comprises the Internet and uses standard communications technologies and/or protocols, e.g., BLUETOOTH®, WiFi, ZIGBEE®, clouding computing, other air to air, wire to air networks, and mesh network protocols to client devices, gateways, and access points. In another embodiment, the network entities can use custom and/or dedicated data communications technologies.

The external source 130 provides information that facilitates the multi-dimensional ranking of providers performed by the provider matching service 140. In one embodiment, the external source 130 includes one or more databases storing information about health providers (e.g., National Provider Identifier (NPI) provided by National Plan & Provider Enumeration System (NPPES), U.S. physician prescribing data (i.e., drugs prescription) provided by First DataBank, Medicare Part D and IMS HEALTH™, patient statistics and evidence-based therapies provided by online resources such as UpToDate®, SK&A, LEXISNEXIS®, and web crawling. The database of the external source 130 may also store medical practice standards (e.g., prescribing guidelines of consensus practice recommendations for different treatments and medication different medical conditions). In some embodiments, the information collected from the external source 130 is collected each time a ranking of providers is conducted and is utilized in that ranking. In other embodiments, the provider matching service 140 builds up one or more of its own databases (e.g., see FIG. 1) of information about providers either in advance or as rankings are performed such that the provider matching service 140 can utilize its own source of information about providers. Such a provider matching service database can be updated regularly to ensure the most accurate and up-to-date information is kept on hand.

The database of the external source 130 or local database of the provider matching service 140 storing data collected from the external source 130 may also store disqualifying events associated with health care providers. Examples of disqualifying events associated with health care providers include that the provider's license to practice has been revoked, that there has been a disciplinary action against the provider, that the provider has retired from practice, and that the provider is currently not accepting new patients. The provider matching service 140 uses the disqualifying events to filter out providers that are not qualified to treat the patient prior to the multi-dimensional ranking.

The external source 130 or local database of the provider matching service storing data collected from the external source 130 may also include historical health data of a patient (e.g., a patient's electronic medical records, or EMRs) from various health record sources (e.g., hospital records, records at the patient's family doctors, or manually inputted data related to the patient's health by the patient's caretakers). The historical health data of a user describes a global view of the user's lifestyle and wellness.

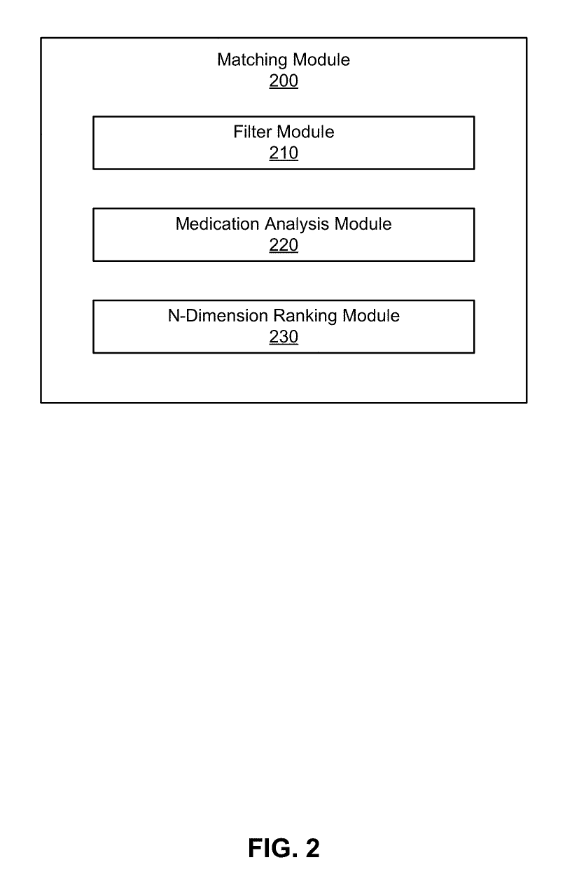

The provider matching service 140 processes the patient input data (e.g., medical conditions and treatment preferences) and provider data from the external source 130 or local database, and provides provider matching results based on the analysis of the patient data from the user input, provider data from the external source 130, and the patient's historical health data from the external source 130 to the client device 110 for display. The health provider matching service 140 is further described below and with reference to FIGS. 2-5.

### Provider Matching Service

The personalized health care provider matching service 140 ranks and selects the best matched health care providers for a patient across multiple dimensions according to the patient's medical conditions and treatment preferences. Each medical condition of the patient represents a dimension; additional medical conditions of the patient represent additional dimensions to rank the providers for the patient. Each medical condition may have one or more treatment options, e.g., medication, psychotherapy or both. The provider matching service 140 ranks the providers across the multiple medical conditions/treatment needs of a patient, where the rankings of the providers represent the providers' competency across multiple dimensions.

In the embodiment illustrated in FIG. 1, the provider matching service 140 has a database-1 142, a database-2 143, a database-3 144, an interface module 146, an analysis module 148, a matching module 200, a recommendation module 150, and a tracking module 152. In alternative configurations, different and/or additional components may be included in the provider matching service 140. For example, the provider matching service 140 may integrate with various third party hardware or software to provide a comprehensive solution to users of the provider matching service 140. The provider matching service 140 can also integrate the health data analysis from the analysis module 148 and tracking module 152 into a user's electronic medical records. Similarly, functionality of one or more of the components may be distributed among the components in a different manner than is described here.

The database-1 142 stores data received from the external source 160. The received data includes provider data, medication data, guideline data and disqualifying events associated with the providers. The provider data includes the information associated with the providers (e.g., NPI, medication prescription data, expertise, provider profile, provider locations, and contact information). The medication data includes the information associated with prescribing of medications (e.g., drug description, side effects, drug composition, different types of medication associated with different medication conditions, place of production, and price). The guideline data includes data associated with practice standards (e.g., prescribing guidelines of consensus practice recommendations for different treatments and medications prescribed for different medical conditions). The disqualifying events include information that disqualifies a provider for treating a patient. Examples of disqualifying events include a revoked license, a disciplinary action, retirement from practice and an indication that the provider is not accepting new patients. In some embodiments, this provider database is a proprietary database of providers and information about them collected from public and private sources (e.g., web and social data) used to profile the competency of providers based on what the providers actually do (e.g., what types of conditions they treat, what medications they prescribe, how often they prescribe medications versus psychotherapy or other treatments, etc.) as opposed to what the providers claim to do.

The database-2 143 stores patient input data received from the client device 110. The received patient input data may include a patient's medical conditions and treatment preferences. The patient input data may also include the patient's medical records, patient's demographic information (e.g., age, gender, ethnicity), patient's drug prescription(s) and consumption information for that drug prescription (e.g., whether the patient adhered to the medication regimen prescribed).

The database-3 144 stores health survey data collected from patient screening (e.g., as shown in FIG. 6A) and analysis data from analysis module 148, matching data from the matching module 200, recommendations from the recommendation module 150, and tracking data from the tracking module 152. In some embodiment, only one database can be used to store all the types of data mentioned above.

The interface module 146 facilitates the communication among the client device 110, the provider matching service 140, and the external source 130. In one embodiment, the interface module 146 interacts with the client devices 110 to receive patient input data and stores the received patient input data in the database-2 143. The interface module 146 also provides the received patient input data to the analysis module 148 and the matching module 200 for further processing. Upon receiving matched providers' information, the interface module 146 instructs the software application module 112 of the client device 110 to display the matched providers' information. In another embodiment, the interface module 146 provides software updates, such as feature updates and security patches, to the software application module 112 of the client device 110 for smooth and secure operation of the provider matching software application on the client device 110.

In another example, the interface module 146 receives information from the external source 130, and stores the received information in the database-1 142. The interface module 146 also provides the received information to the matching module 200 for ranking providers in one or multiple dimensions.

The analysis module 148 analyzes patient input data for generating pre-conditions of provider matching. In one embodiment, the pre-conditions include the patient's medical conditions and constraints based on the patient's treatment preferences. Each of the patient's medical conditions represents one dimension in ranking the providers by the matching module 200. For example, provider matching for a patient currently experiencing following medical conditions, depression, anxiety, alcohol/substance abuse, ADHD, bipolar, and psychosis can find providers for each medical condition (i.e., a single dimension matching) and for a combination of multiple conditions (e.g., a two-dimensional matching for treating depression and anxiety). In one embodiment, the analysis module 148 determines the patient's medical conditions through a health survey presented to the user (e.g., as shown in FIG. 6A and FIG. 6B). According to the user feedback, the analysis module 148 determines the patient's mental well-being and medical conditions, including an estimate of severity of the patient's mental well-being and medical conditions.

The analysis module 148 determines constraints based on the patient's treatment preferences (as shown in FIG. 6C and FIG. 6D). The patient's treatment preferences can be divided into two sets: preference for treatment options (e.g., medication only, psychotherapy only, or both), and personal preferences (e.g., a geographical location, time available, language preferences, gender, age, cultural considerations, and insurance plans accepted). Each of the patient's personal preferences is used by the matching module 200 to exclude providers that do not match with the patient's personal preference. For example, a provider is located beyond the distance limit preferred by the patient is not included in the matching by the matching module 200. However, in some embodiments, the providers not meeting the preferences or only meeting some preferences are not necessarily excluded, but instead those providers can also be ranked along with the rest. In this case, the providers who do not meet one or more preferences might be highlighted are marked in red and the preference not met indicated next to the provider so the patient is aware of the preferences not met. Alternatively, the preferences not met can be considered another factor on which the provider is ranked. In some embodiments, the patient can customize whether providers not meeting certain preferences are excluded completely or not.

The matching module 200 selects the best matched providers for a patient based on the analysis data of the patient from the analysis module 146. The matching module 200 filters out disqualified providers and analyzes the remaining provides based on the patient's medical conditions and treatment preferences. Based on the analysis, the matching module 200 ranks the remaining providers and determines the best matched providers for the patient. Similarly, the matching module 200 may rank the providers in a multi-dimensional space, where the dimensions are represented by non-medical condition type of factors, such as cost of treatment and location distance from a provider. The matching module 200 is further explained in conjunction with description of FIG. 2.

The recommendation module 150 generates recommendations associated with best matched providers for a patient based on the patient's medical conditions and preferences. In one embodiment, the recommendation module 152 generates recommendations based on the matching data obtained from the matching module 200. The recommendation module 152 can provide a list of matched providers as the recommendations. The list of the matched providers includes information associated with each matched provider, e.g., contact information, location, NPI number, gender, new patient acceptance status, availability, related medical conditions and treatments that the provider handles, language, education, work experience, and other suitable information related to the matched providers. In some embodiments, the recommendation module 150 also generates instructions on how to present the matching data from the matching module 200 and recommendations, and provides the presentation instructions associated with matching data and recommendations to the client device 110 for display to the patient.

In response to the recommendations provided by the recommendation module 150, the patient may select a provider to provide treatment. The patient can schedule an appointment with the provider separately or through the provider matching service 140 that connects the patient and provider. In some embodiments, the provider matching service 140 includes or is integrated with a health concierge service that not only generates recommendations but helps to manage the relationship between the patient and provider. In these embodiments, the recommendation module 150 may schedule an appointment for the patient with the provider and provider a confirmation to both parties of the appointment scheduled. For example, the provider matching service 140 could provide confirmation to the patient in the patient user interface or by sending a message (e.g., text message, email, instant message, etc.) to the patient. If there is rescheduling that must occur or if there are any other details associated with the appointment that need to be managed, the recommendation module/concierge service can coordinate and manage these details such that there is minimal effort on the side of the patient and provider, thereby increasing the likelihood that the patient will ultimately make it to the appointment and get the needed treatment. The recommendation module 150 also sends reminders to the patient near to or on the day of the appointment to increase the chances that the appointment is not missed.

The tracking module 152 tracks patient responses to a treatment provided by a health care provider matched by the matching module 200. For example, the tracking module 152 monitors outcome of a treatment and evaluates the patient's medical condition before and after the treatment. If the tracking data shows the patient's medical condition is getting worse, the tracking module 152 may instruct the recommendation module 150 to recommend patient consulting to the provider that provided the treatment. In some embodiments, the tracking module 152 may report the patient's medication condition post treatment to the matching module 200 to find a new provider to treat the patient's worsened medical condition. The tracking module 152 can also contact the patient regularly to monitor the outcome of the treatment, including calling or sending messages to the patient or contacting the patient through the patient user interface, sending follow up questions to the patient regarding quality of treatment and patient satisfaction, connecting the patient with a coach to provide encouragement and answer questions, among other mechanisms for monitoring the patient.

In some embodiments, the tracking module 152 tracks recommended providers' performance and evaluates providers' performance based on tracking data. A provider's performance includes outcome of the treatment and the patient's feedback about the treatment. Based on the evaluation, the tracking module 152 may generate adjustment factors associated with the provider's performance and provides the adjustment factors to the matching module 200 for adjusting the provider's ranking. For example, if the provider has good performance (e.g., the medical condition of the patient becomes better), the ranking of the provider is increased by applying the adjustment factor in favor of the provider's ranking. If the provider has bad performance (e.g., the medical condition of the patient becomes worse after the treatment), the ranking of the provider is decreased by applying the adjustment factor to negatively affect the provider's ranking.

### Single- and Multi-Dimensional Provider Matching

FIG. 2 is a block diagram of a matching module 200 of the provider matching service 140 to provide best matched providers to a patient based on the patient's medical conditions and treatment preferences according to one embodiment. In the embodiment illustrated in FIG. 2, the matching module 200 has a filter module 210, a medication analysis module 220, and N-dimension matching module 230, where parameter N represents the dimension of the matching and N>>1. When N=1, e.g., treating one particular behavioral health condition, such as depression, of a patient, the matching module 230 generates single-dimensional rankings of providers for treating that particular behavioral health condition for the patient; when N>1, e.g., treating more than one behavioral health condition, such as depression and anxiety, of a patient, the matching module 230 generates multi-dimensional rankings of providers for treating both behavioral health conditions for the patient. In alternative configurations, different and/or additional components may be included in the matching module 200. Similarly, functionality of one or more of the components may be distributed among the components in a different manner than is described here.

The filter module 210 filters out disqualified health care providers based on constraints generated from a patient's treatment preferences and based on disqualifying events associated with providers. A disqualified health care provider is not included in the provider matching process for the patient. In one embodiment, the filter module 210 retrieves a patient's treatment preferences from the database-2 143 and disqualifying events associated with providers from the database-1 142. The filter module 210 uses the patient's treatment preferences and disqualifying events to filter out providers that are not qualified to treat the patient prior to the provider matching process.

The medication analysis module 220 measures providers' levels of competency for treating each medical condition of a patient, e.g., based on the providers' drug prescription patterns in treating the medical condition against a reference practice standard (e.g., NPPES recommendation for treating the medical condition). Medication prescription patterns by different providers provide a way to differentiate the providers against the reference standard for the medication prescription. Typically, each medical condition has a different number of treatments. Taking behavioral health conditions as an example, each behavioral health condition has a different set of N line treatments, where each line treatment is represented by a line of medications and a competent provider prescribes the appropriate first line medications before the second line medications. The medication analysis module 220 can rank the providers based on their levels of competency in treating a medical condition of the patient. In one embodiment, a provider's competency in treating a behavioral health condition is measured in terms of (1) diversity of medication prescription by the provider for each line of treatment, (2) concentration of medication prescription by the provider for each line of treatment; and (3) differences among the lines of treatments by the provider.

First, the medication analysis module 220 analyzes the diversity of medication prescriptions by one type of health provider (e.g., psychiatrists, internal medicine and general practice) for each line of treatments. The diversity of medication prescriptions by a provider describes how many different types of medications the provider prescribed, and the level of diversity of medication prescription of a provider is directly associated with the level of sophistication of the provider in prescribing medications for treating a medical condition. For example, a provider that has more variation in the medications she prescribes to treat a condition is determined by the system to have a higher level of sophistication in treating that condition than a provider that has less variation or fewer different medications prescribed. The provider having more medication diversity is assumed to be better skilled at tailoring the drug regimen to the particular condition and patient.

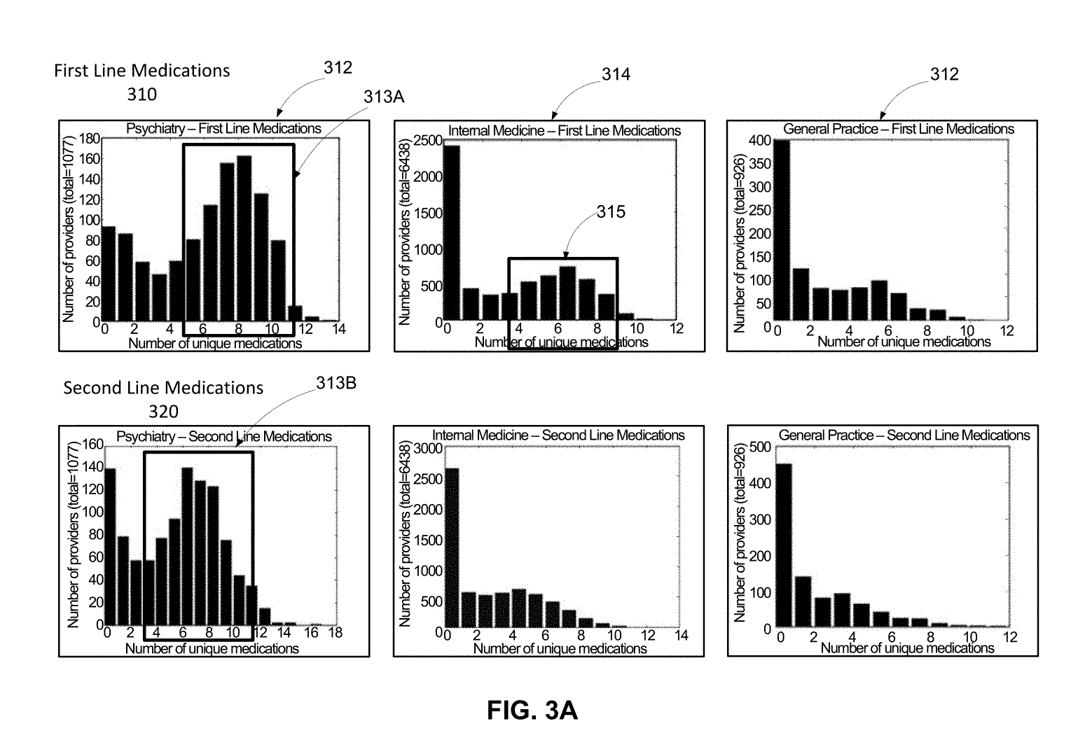

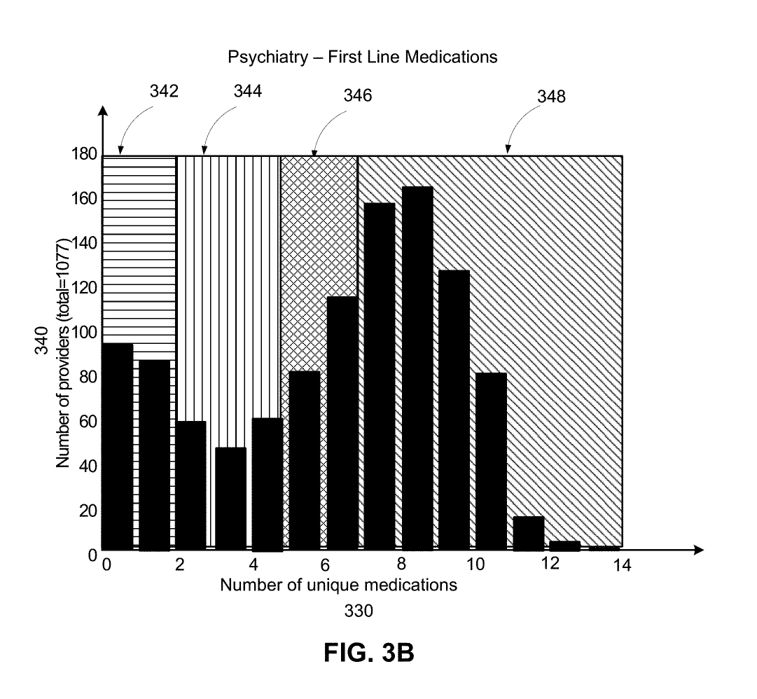

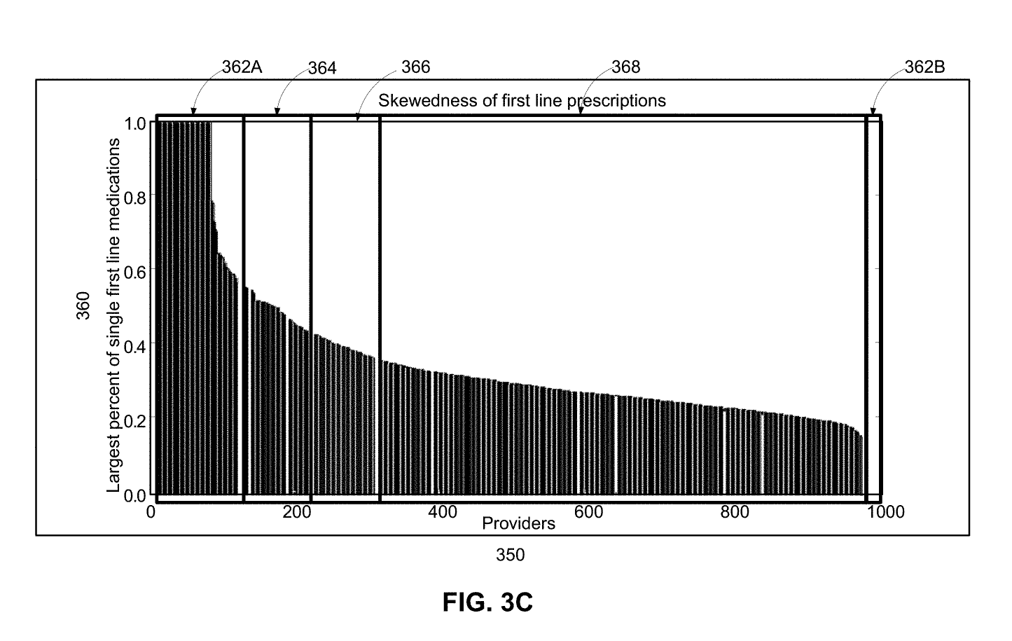

Turning now to FIG. 3A, FIG. 3A is a graph illustrating exemplary diversity of medication prescription for a behavioral health condition by 3 different types of providers across two lines of medications. The behavioral health medications by each type of provider are separated into two lines of treatment; each line of treatment is represented by a line of medications. FIG. 3A shows histograms of number of providers (vertical axis) versus number of unique medications (horizontal axis) (e.g., different types of medications) for three types of health care providers (e.g., psychiatrist 312, internal medicine 314, and general practice 316) at a first line of medication 310 and a second line of medication 320. As shown in FIG. 3A, histogram distribution 313A over the unique medication range (e.g., medication numbers 5-11) of the psychiatrist 312 shows highest level of sophistication of medication prescription compared with internal medicine (e.g., histogram distribution 315) and general practice providers. The higher level of sophistication of medication prescription by psychiatrists is expected and is consistent with the standard practice guideline for treating behavioral health conditions. The higher level of sophistication of medication prescription (e.g., histogram distribution 313B) by psychiatrists is not only observed at the first line of medication 310, but also is similarly observed at the second line of medication 320.

FIG. 3B is a graph illustrating exemplary diversity of medication prescription by a psychiatrist across a first line of medications. As shown in FIG. 3B, there are a total of 1077 psychiatrists being evaluated (vertical axis), and there are a total of 14 unique mediations being prescribed (horizontal axis) by the psychiatrists as the first line medications. The medication analysis module 220 identifies the median (or mean or mode) of the distribution of the psychiatrists' medication prescription data with reference to a predefined minimum threshold of medication diversity. The psychiatrists' medication prescription data are divided into 4 regions (region-1 342, region-2 344, region-3 346, and region-4 348) based on the median value. For simplicity, each region can be assigned a score against the identified median distribution, and the score of a region represents the competency level of the psychiatrists associated with the corresponding region in treating the behavioral health condition.

The medication analysis module 220 generates single-dimensional rankings of the psychiatrists in treating the behavioral health condition of the patient based on the scores. The region-4 348, which is larger than the median value, is assigned lowest score, e.g., 0, which indicates the highest level of sophistication of medication prescription, and psychiatrists whose medication prescription patterns are similar to the distribution shown in region-4 348 will get higher rankings than other psychiatrists whose medication prescription patterns correspond to the distributions shown in other 3 regions. The region-3 346, which is close to the median value, is assigned a higher score than the region-4 348, but a lower score than the region-1 342 and the region-2 344, and psychiatrists whose medication prescription patterns are similar to the distribution shown in region-3 346 will get next higher rankings. The region-2 344, which is far from the median value, is assigned a higher score than the region-3 246, and the region-1 342 has the highest score than other three regions; psychiatrists whose medication prescription patterns are similar to the distribution shown in region-2 344 and the region-1 342 will get penalized in their rankings compared to the psychiatrists associated with the region-4 348 and the region-3 346, and the psychiatrists associated with the region-1 342 are automatically disqualified for treating the behavioral health condition being analyzed. Same or similar methods can be applied to all other relevant health care providers, as well as other lines of treatments.

Next, the medication analysis module 220 analyzes concentration of medication prescription by one type of health care providers (e.g., psychiatrist) for each line of treatment. The concentration of medication prescription describes the percentage of each type of medication prescribed by a health care provider among the total number of medications prescribed by a provider. Generally, a provider who constantly prescribes only one or two types of medications for treating a medical condition should have lower rankings; similarly, a provider who constantly prescribes in high percentage across each type of medications for treating a medical condition also should have lower rankings. The medication analysis module 220 uses the analysis of the concentration of medication prescription to exclude providers who prescribed medications with concentration patterns in two extremes described above.

FIG. 3C is a graph illustrating exemplary concentration of a first line medication prescription by providers according to one embodiment. As shown in FIG. 3C, the distribution of the first line medications prescribed by the providers (e.g., psychiatrists) is skewed from its normal distribution, which assumes symmetric distribution data around mean. The distribution of the first line medications prescribed by providers is divided into 5 regions: region-1 362A, region-2 364, region-3 366, region-4 368, and region 362B, based on the average percentage value of each type of medications prescribed by the providers associated with the corresponding regions. The distribution of the region-4 368 is around 40% compared with a predefined percentage threshold value, and the providers associated with the region-4 will have higher rankings than other providers associated with other 3 regions. The distribution of the region-3 366 is between 40% and 50%, and the providers associated with the region-3 will have next higher rankings compared with the providers associated with the region-4 368. The distribution of the region-2 364 is between 50% and 60%, and the providers associated with the region-2 will have the rankings that are lower than the rankings of the providers associated with the region-3 366. The distribution of the region-1 362A, which is above 60%, and the distribution of the region 362B represent the two extremes of the concentration of the first line medication prescription by the providers, where the providers associated with the region-1 362A and the region 362B are excluded from the matching for treating the behavioral health condition of the patient. Same or similar method can be applied to all other relevant health care providers, as well as other lines of treatments.

The medication analysis module 220 further analyzes the differences among the lines of treatments for each type of health care provider. The differences can be used to derive volume and adherence to medication treatments by the providers. In one embodiment, the lines of treatments are set up such that competent providers for treating a given medical condition should prescribe the appropriate first line medications before the second line medications, and competent providers should have a population of patients under treatment that reflect decreasing frequency of use across lines of medications with experts most utilizing the later lines of treatment. In other words, assuming that a provider's prescribed medications are divided into three lines, a competent provider should prescribe the medications in terms of medication volumes in the following orders: first line>second line>third line.

The medication analysis module 220 may apply the analysis described above for each medical conditions of a patient and generates one-dimensional rankings of providers in treating the corresponding medical condition of the patient. Similarly, the medication analysis module 220 may apply the analysis described above for each type of provider in treating a given medical condition a patient, and generates one-dimensional rankings of providers in treating the medical condition of the patient. Furthermore, the medication analysis module 220 may apply the analysis described above to rank providers based on factors such as cost of average medication treatments for each medication by the providers.

The N-dimension ranking module 230 of the matching module 200 ranks the health care providers associated with the patient's medication conditions and treatment preferences in N dimension. Each medical condition of the patient represents a dimension in the matching process; and each medical condition has one or more treatment options, e.g., medication and psychotherapy. Using the examples shown in FIG. 6B and FIG. 6D, the patient has 6 medical conditions: depression, anxiety, alcohol abuse, ADHD, bipolar, and psychosis; the patient can choose one or more treatment options from medication and psychotherapy for each of the medical conditions. This gives a total of 12 dimensions (6 medical conditions*2 methods of treatments) for the ranking module 230 to rank the providers for the patient.

In one embodiment, the N-dimension ranking module 230 utilizes a multi-objective optimization method, e.g., Pareto frontier method, to rank providers for all the medical conditions associated with the patient. The ranking module 230 applies the Pareto frontier algorithm to all dimensions simultaneously and generates rankings of the providers in the dimensions. The N-dimension ranking module 230 creates a ranking map in N-dimensions based on the rankings in all dimensions. The ranking map is a data structure for representing the rankings in the dimensions being evaluated, and any suitable data structure known to those of ordinary skill in the art can be used for representing the rankings. Using the example above, the ranking module 230 can rank the providers in 12 dimensions using the Pareto frontier method and generates a ranking map in 12 dimensions. The ranking in each dimension is relative and independent; a given provider's rank is determined by the number of other providers better than and the number of providers worse than the given provider; Provider A is better than Provider B if and only if Provider A is better than Provider B in every dimension.

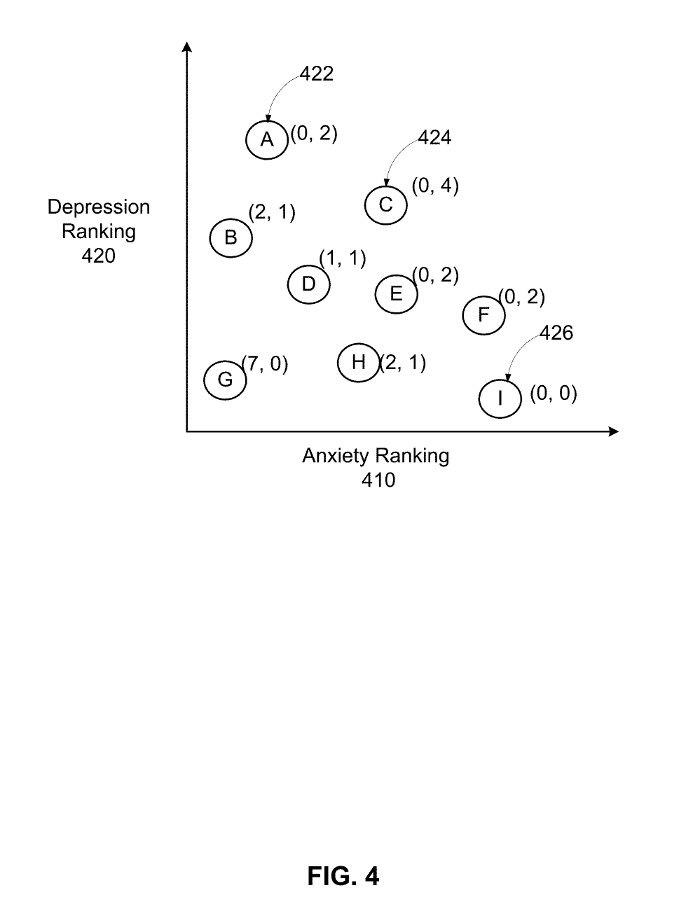

In one embodiment, the N-dimension ranking module 230 provides information indicating how many other providers are better than a given provider in a dimension. FIG. 4 is a graph illustrating exemplary multi-dimensional rankings of 9 providers for two different medical conditions (depression and anxiety) according to one embodiment. FIG. 4 shows a two-dimensional ranking map of 9 providers (represented by the circles in FIG. 4) in terms of depression ranking (vertical axis) and anxiety ranking (horizontal axis). Each given provider has a pair of numbers: the left number indicating the number of other providers who are better than the given provider; the right number indicating the number of other providers who are worse than the given provider. Taking provider A 422 as an example, 9 providers treated the patient for both depression and anxiety. The provider A 422 has a pair of numbers (0,2), which means no one is better than the provider A 422, and the provider A 422 is better than two other providers—provider B and provider G—in the depression-anxiety dimensions.

In some embodiments, providers can be selected based on severity level of each medical condition the patient is currently experiencing. For example, if a patient has severe anxiety and mild depression, then the providers with higher rankings in treating anxiety are preferred than the providers with lower rankings in the treating anxiety. Using the two-dimensional ranking map shown in FIG. 4, the provider 426 can be selected for treating the patient suffering from severe anxiety because the provider 426 has the highest ranking in the dimension of anxiety among the 9 providers. If a patient has mild anxiety but severe depression, the provider 422 can be selected because the provider 422 has the highest ranking in the dimension of depression among the 9 providers. If a patient has anxiety and depression at a similar level of severity, the provider 424 can be selected because the provider 424 has a relatively high ranking in both anxiety dimension and depression dimension among the 9 providers.

The matching module 200 can access a patient's needs across different medical conditions and applies different weights to different corresponding dimensions in ranking the providers. In some embodiments, the matching module 200 applies weight factors to adjust the ranking in a single dimension and in multiple dimensions. For example, in generating rankings in a single dimension, the medication analysis module 220 of the ranking module 230 identifies the most common medication prescribing pattern for each line of medications, penalizes providers who prescribe too few medications or too much of a single medication, and also penalizes providers who prescribe more second line medications than the first line medications. The weights applied by the medication analysis module 220 in the single dimensional ranking are reflected by the amount of penalty applied in the ranking process.

The weight factors may vary depending on a patient's medical conditions. For example, the weight factors are based on the tracking data from the tracking module 152, as discussed earlier. For another example, the weight factors are also based on the severity level of each medical condition the patient experiencing from the analysis module 146. For a patient having severe anxiety and mild depression, providers with more treatment sophistication treating anxiety would be ranked higher. Other patient level weighting strategies can be considered by the matching module 200 in ranking providers for a patient. For example, the matching module 200 may give higher weights to medical conditions which have more functional or quality of life impairment.

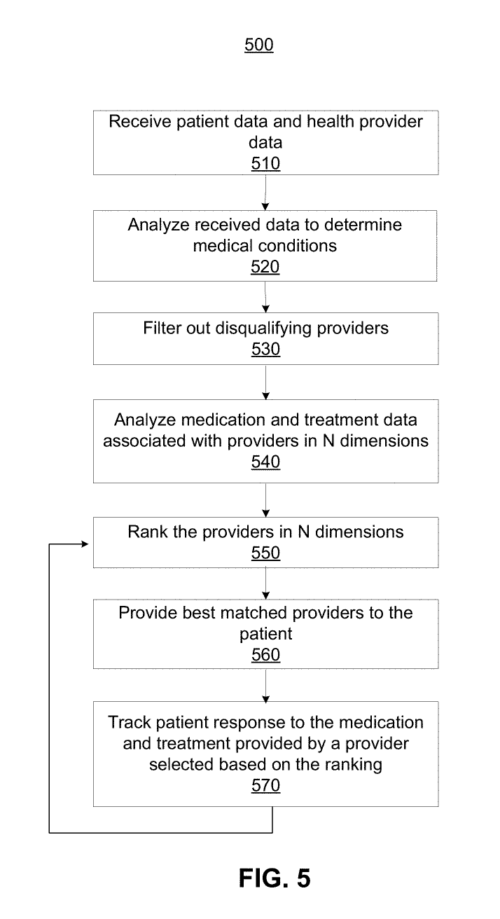

FIG. 5 is an exemplary flowchart illustrating a process 500 performed by the provider matching service 140 for matching health care providers with a patient's need based on the patient's medication conditions and preferences according to one embodiment. The process 500 may include different or additional steps than those described in conjunction with FIG. 5 in some embodiments or perform steps in different orders than the order described in conjunction with FIG. 5.

The provider matching service 140 receives 510 patient data of a given patient and health care provider data. The patient data includes current medical conditions of the patient and the patient's preferences for treatment. The health care provider data includes information describing the providers, their medication prescribing patterns, and disqualifying events. The provider matching service 140 analyzes 520 received data to determine the patient's medical conditions. For example, the provider matching service 140 determines how many medical conditions the patient is currently experiencing and the severity of each medical condition. Each medical condition of the patient represents a dimension in ranking the providers for the patient. The provider matching service 140 filters out 530 disqualified providers based on the disqualifying events and the patient's preferences for treatment. The provider matching service 140 analyzes 540 medication and treatment data associated with the providers in multiple dimensions determined by the combination of the patient's medical conditions and preferences for treatment. The provider matching service 140 ranks 550 the providers in the multiple dimensions. The provider matching service 140 provides 560 one or more best matched providers to the patient based on the ranking. The provider matching service 140 tracks 570 patient responses to the medication and treatment provided by a best matched provider and provides tracking data to adjust the ranking of the providers. The provider matching service 140 repeats the steps of 510 to 570 in real time and continuously as long as the provider matching service 140 is used.

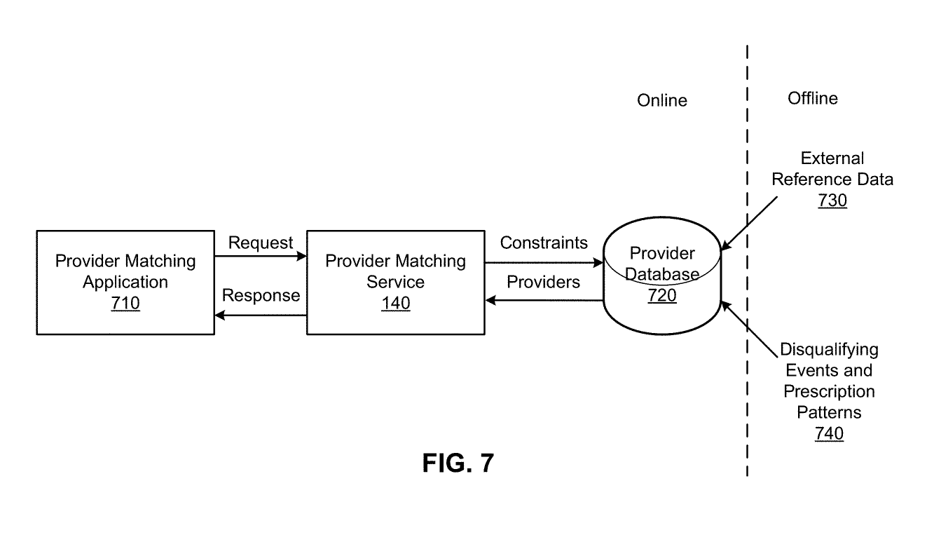

FIG. 7 is a flow diagram of providing best matched providers to a patient based on the providers' multi-dimensional rankings according to one embodiment. Initially, a user (e.g., a patient) uses his/her client device that executes a provider matching application 710 on the client device to send a request for finding one or more providers to treat his/her medical conditions in accordance with his/her preferred treatment options. The provider matching service 140 receives the request, extracts the patient's medical conditions and preferences for treatment, and searches a provider database 720 for the best matched providers. The provider database 720 stores information from external reference data 730, such as prescribing guidelines of consensus practice recommendations for different treatments and medication different medical conditions, and disqualifying events associated with the providers and providers' medication prescribing data 740. The provider matching service 140 applies the disqualifying events and constraints generated from the patient's preferences for treatment to exclude providers from the ranking, and ranks the remaining providers in one or more dimensions determined by a combination of the patient's medical conditions and treatment preferences. Based on the ranking, the provider matching module 140 selects one or more best matched providers and provides the selected providers as a response to the patient. The patient uses the received response to select his/her provider(s) to treat his/her medical conditions in accordance with his/her preferences for treatment. In one embodiment, the provider matching process can be performed in real time (i.e., online) and the provider database 720 can be updated offline.

### Conclusory Statements

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a nontransitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a nontransitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, from a patient, information describing medical conditions and treatment preferences of the patient, each medical condition of the patient representing one or more dimensions in ranking a plurality of providers in treating the patient;
determining a total number of dimensions for ranking the plurality of the providers for treating the patient based on a combination of the medical conditions and the treatment preferences of the patient;
identifying a subset of providers of the plurality of providers as disqualified providers based on the patient's treatment preferences and a plurality of disqualifying events associated with the plurality of providers,
for each dimension of the total number of dimensions:
ranking qualified providers of the plurality of providers in the dimension;
generating a multi-dimensional ranking map based on rankings of the qualified providers in each dimension of the total number of dimensions;
selecting one or more providers from the plurality of providers based on the multi-dimensional ranking map ranking the qualified providers; and
providing for display to the patient the selected providers.

2. The method of claim 1, wherein the medical conditions of the patient are behavioral health conditions of the patient, the medical conditions comprising at least one of the following:
depression;
anxiety;
alcohol or substance abuse;
attention deficit hyperactivity disorder (ADHD);
post-traumatic stress disorder (PTSD);
specific phobia;
social anxiety;
bipolar disorder; and
schizophrenia and psychosis.

3. The method of claim 1, wherein the treatment preferences of the patient comprise at least one of the following:
preferences of the patient with regard to different types of treatment options; and
personal preferences of the patient in a provider who will provide treatment.

4. The method of claim 3, wherein the treatment options comprise at least one of medication, psychotherapy and combination of medication and psychotherapy.

5. The method of claim 3, wherein the personal preferences of the patient for a treatment comprise at least one of the following:
geographical location of the provider;
time availability of the provider;
language preference for the provider;
gender of the provider;
age of the provider; and
insurance plan accepted by the provider.

6. The method of claim 1, wherein the plurality of disqualifying events associated with the plurality of providers comprise at least one of the following:
the provider having a revoked license;
the provider having undergone a disciplinary action;
the provider having retired from practice; and
the provider having an indication of not accepting new patients.

7. The method of claim 1, wherein ranking the qualified providers of the plurality of providers in a dimension comprises measuring the competency of the qualified providers in treating the medical condition in the dimension.

8. The method of claim 7, wherein measuring the competency of the qualified providers in treating the medical condition in the dimension comprises:
analyzing diversity of medication prescription by the qualified providers for the medical condition;
analyzing volume of and adherence to medication treatments by the qualified providers for the medical condition;
analyzing cost of average medication treatments for the medical condition by the qualified providers; and
generating rankings of the providers in the dimension based on the diversity analysis, the volume and adherence analysis, and the cost analysis.

9. The method of claim 1, wherein ranking the qualified providers of the plurality of providers in the dimension comprises applying a multi-objective ranking algorithm to the medication prescription patterns associated with each qualified provider.

10. The method of claim 1, wherein the multi-dimensional ranking map indicates a multi-dimensional ranking of each provider of the qualified providers, wherein a provider is better than another provider if and only if the provider has a higher ranking in each dimension than the other provider.

11. A non-transitory computer-readable storage medium storing executable computer program instructions, the computer program instructions comprising code for:
receiving, from a patient, information describing medical conditions and treatment preferences of the patient, each medical condition of the patient representing one or more dimensions in ranking a plurality of providers in treating the patient;
determining a total number of dimensions for ranking the plurality of the providers for treating the patient based on a combination of the medical conditions and the treatment preferences of the patient;
identifying a subset of providers of the plurality of providers as disqualified providers based on the patient's treatment preferences and a plurality of disqualifying events associated with the plurality of providers,
for each dimension of the total number of dimensions:
ranking qualified providers of the plurality of providers in the dimension;
generating a multi-dimensional ranking map based on rankings of the qualified providers in each dimension of the total number of dimensions;
selecting one or more providers from the plurality of providers based on the multi-dimensional ranking map ranking the qualified providers; and
providing for display to the patient the selected providers.

12. The computer-readable storage medium of claim 11, wherein the medical conditions of the patient are behavioral health conditions of the patient, the medical conditions comprising at least one of the following:
depression;
anxiety;
alcohol or substance abuse;
attention deficit hyperactivity disorder (ADHD);
post-traumatic stress disorder (PTSD);
specific phobia;
social anxiety;
bipolar disorder; and
schizophrenia and psychosis.

13. The computer-readable storage medium of claim 11, wherein the treatment preferences of the patient comprise at least one of the following:
preferences of the patient with regard to different types of treatment options; and
personal preferences of the patient in a provider who will provide treatment.

14. The computer-readable storage medium of claim 13, wherein the treatment options comprise at least one of medication, psychotherapy and combination of medication and psychotherapy.

15. The computer-readable storage medium of claim 13, wherein the personal preferences of the patient for a treatment comprise at least one of the following:
geographical location of the provider;
time availability of the provider;
language preference for the provider;
gender of the provider;
age of the provider; and
insurance plan accepted by the provider.

16. The computer-readable storage medium of claim 11, wherein the plurality of disqualifying events associated with the plurality of providers comprise at least one of the following:
the provider having a revoked license;
the provider having undergone a disciplinary action;
the provider having retired from practice; and
the provider having an indication of not accepting new patients.

17. The computer-readable storage medium of claim 11, wherein the computer program instructions for ranking the qualified providers of the plurality of providers in a dimension comprise computer program instructions for measuring the competency of the qualified providers in treating the medical condition in the dimension.

18. The computer-readable storage medium of claim 17, wherein the computer program instructions for measuring the competency of the qualified providers in treating the medical condition in the dimension comprise computer program instructions for:
analyzing diversity of medication prescription by the qualified providers for the medical condition;
analyzing volume of and adherence to medication treatments by the qualified providers for the medical condition;
analyzing cost of average medication treatments for the medical condition by the qualified providers; and
generating rankings of the providers in the dimension based on the diversity analysis, the volume and adherence analysis, and the cost analysis.

19. The computer-readable storage medium of claim 11, wherein the computer program instructions for ranking the qualified providers of the plurality of providers in the dimension comprise computer program instructions for applying a multi-objective ranking algorithm to the medication prescription patterns associated with each qualified provider.

20. The computer-readable storage medium of claim 11, wherein the multi-dimensional ranking map indicates a multi-dimensional ranking of each provider of the qualified providers, wherein a provider is better than another provider if and only if the provider has a higher ranking in each dimension than the other provider.

21. A computer-implemented method comprising:
receiving, from a patient, information describing medical conditions and treatment preferences of the patient, each medical condition of the patient representing one or more dimensions in ranking a plurality of providers in treating the patient;
determining a total number of dimensions for ranking the plurality of the providers for treating the patient based on a combination of the medical conditions and the treatment preferences of the patient;
for each dimension of the total number of dimensions:
ranking the plurality of providers in the dimension; and
generating a multi-dimensional ranking map based on rankings of the providers in each dimension of the total number of dimensions.

22. The method of claim 21, further comprising:
identifying a subset of providers of the plurality of providers as disqualified providers based on the patient's treatment preferences and a plurality of disqualifying events associated with the plurality of providers,
assigning weights to the dimensions, wherein the weights assigned to the dimensions are determined based on severity level of each medical condition; and
ranking the plurality of providers in each dimension, wherein the rankings of the plurality of providers are directly correlated with the weights assigned to the dimension.

23. The method of claim 21, further comprising:
selecting one or more providers from the plurality of providers based on the multi-dimensional ranking map ranking the plurality of providers; and
providing for display to the patient the selected providers.

24. The method of claim 21, further comprising:
tracking performance of the one or more providers selected for treating the patient; and
tracking response from the patient receiving treatment from each provider selected for treating the patient.

25. The method of claim 24, further comprising:
adjusting weights assigned to the providers selected for treating the patient based on the tracking of the providers' performance and the patient response or preferences.
